(19) United States
(12) Patent Application Publication
(10) Pub. No.: US 2011/0010737 A1
(43) Pub. Date: Jan. 13, 2011

(54) METHOD AND APPARATUS FOR NOTIFICATION-BASED CUSTOMIZED ADVERTISEMENT

(75) Inventors: Imed Bouazizi, Tampere (FI); Miska Hannuksela, Ruutana (FI)

Correspondence Address: DITTHAVONG MORI & STEINER, P.C., 918 Prince Street, Alexandria, VA, 22314, US

(73) Assignee: Nokia Corporation

(21) Appl. No.: 12/501,355

(22) Filed: Jul. 10, 2009

(51) Int. Cl. H04N 7/025

(52) U.S. Cl. 725/34

(57) ABSTRACT

Systems and methods are provided for realizing fully customized mobile advertisement services based on notifications. Such systems and methods in accordance with various embodiments, allow for full customization of advertisement content, display time, and location. A notification framework may be utilized to transmit and receive notification messages that include information about at least one of a scheduled advertisement period, announcement of the availability of at least one advertisement, and a trigger of presentation associated with the advertisement.

### FIELD

Various embodiments relate generally to mobile advertising. More particularly, various embodiments relate to realizing fully customized advertisement services for based on notifications.

### BACKGROUND

This section is intended to provide a background or context to various embodiments recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Digital Video Broadcasting Convergence of Broadcast and Mobile Services (DVB CBMS) has developed a notification framework for Internet Protocol Datacast (IPDC) over Digital Video Broadcasting-Handheld (DVB-H). The notification framework will enable the delivery of different types of notification events, e.g., about forthcoming and unscheduled events, to a large population of receivers. Notification events are delivered in the form of notification messages that may be carried over the broadcast channel DVB-H or over an interactivity channel (e.g., a 3G network). Additionally, the notification messages may typically comprise a number of parts.

It should be noted that notification messages may also be delivered over an interactive channel (e.g. a 2G or 3G network or WLAN). For this purpose, a receiving terminal may need to register its coordinates to get the information about new notification messages pushed to the receiving terminal. The receiving terminal may then access the notification service in poll mode to check periodically for new notification messages.

Mobile advertising, for example, is anticipated as becoming a key revenue generator for network operators and content providers in the near future. Mobile TV may become one of the most important distribution channels for driving mobile advertising. Mobile TV offers an opportunity for providing mobile advertisements to a growing user population.

### SUMMARY OF VARIOUS EMBODIMENTS

Various embodiments are directed to a method, apparatus, and computer program product, embodied on a computer-readable medium, for encoding an advertisement content, into a media file, according to a target usage environment, assigning filtering information to the media file to enable customized selection of the said advertisement, transmitting an audio/visual (A/V) stream carrying media data of the advertisement and transmitting a notification stream synchronized to the audio/visual stream wherein the notification stream carries messages regarding at least one of an announcement of availability of the advertisement, information regarding scheduled advertisement periods, and trigger information regarding presentation of the advertisement.

Other embodiments are directed to a method, apparatus, and computer program product, embodied on a computer-readable medium, for receiving a notification message regarding at least one advertisement, at a terminal, arranging, by the terminal, for presentation of an advertisement, selected from the at least one advertisement, and presenting the selected advertisement to a user of the terminal. The notification message comprises information regarding at least one of a scheduled advertisement period, announcement of availability of the at least one advertisement and a trigger of presentation associated with an advertisement.

These and other advantages and features of various embodiments, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

Embodiments of various embodiments are described by referring to the attached drawings, in which:

FIG. 1 is an example of a conventional notification message structure;

FIG. 2 illustrates mobile advertisement delivery over a broadcast channel for Mobile TV in accordance with various embodiments;

FIG. 3a is a flow chart illustrating network processes performed for delivering advertisements in accordance with various embodiments;

FIG. 3b is a timeline illustrating the utilization of a trigger for the presentation of an advertisement in accordance with various embodiments;

FIG. 4 is a flow chart illustrating terminal processes performed for receiving and realizing mobile advertising in accordance with various embodiments;

FIG. 5 is a flow chart illustrating processes performed from a user perspective for realizing customized mobile advertising in accordance with various embodiments;

FIG. 6 is an overview diagram of a system within which various embodiments may be implemented;

FIG. 7 is a perspective view of an electronic device that may be used in conjunction with the implementation of various embodiments; and

FIG. 8 is a schematic representation of the circuitry which may be included in the electronic device of FIG. 7.

FIG. 9 is a representation of a server within which various embodiments may be implemented.

### DETAILED DESCRIPTION OF VARIOUS EMBODIMENTS

Systems and methods for realizing fully customized advertisement services associated with media services, e.g., mobile TV, based on notifications are disclosed in various embodiments. Such systems and methods in accordance with various embodiments allow for full customization of advertisement content, display time, and location.

The procedure(s) for realizing and implementing user-targeted advertisement have not yet been defined. Solutions for such user-targeted advertising would preferably allow flexible time and location-based advertisements. Many of the mobile devices supporting broadcast media services, e.g. mobile television (TV), are also endowed with an interactivity channel and other functionalities such as location information. The interactivity channel and/or the other functionalities are used to pave the way for more targeted advertisements that directly address the needs and interests of users as will be described in greater detail below.

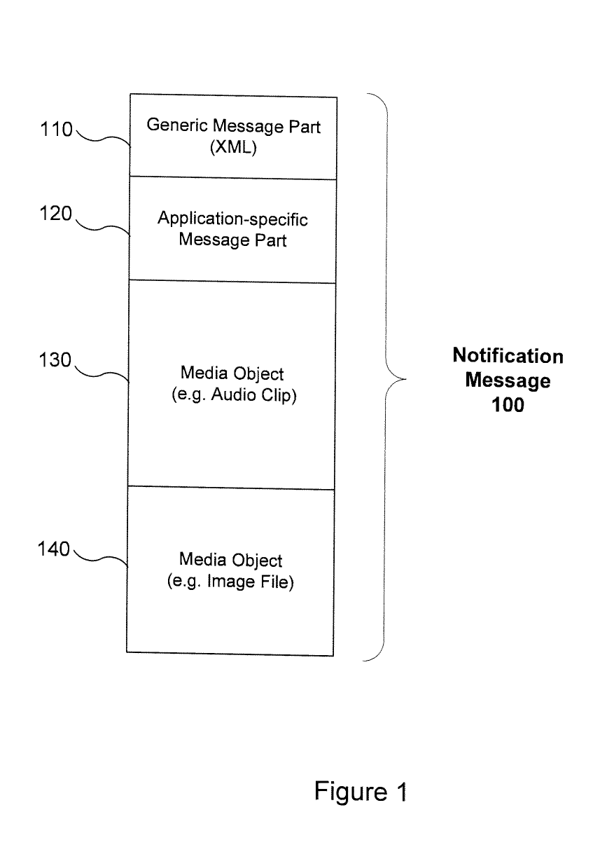

FIG. 1 illustrates a conventional notification message structure. A notification message 100 may include a generic message part 110, an application-specific part 120, an media objects such as an audio clip/file 130 and an image file 140. The generic message part 110 may be an Extensible Markup Language (XML) fragment that is consumed by the notification framework and carries generic information about the notification message that, e.g., enables the extraction, filtering, and processing of the notification message. The application-specific message part 120 is another fragment (typically in the XML format) that is consumed by a notification application capable of processing the application-specific part of the notification message. The application-specific part contains information about the event that is notified to the receiver or user, i.e., the content of the notification message. Auxiliary data comprises the other notification message parts, e.g., audio or image/video files 130 and 140, respectively. Such parts are typically media objects which are used for the presentation or execution of the notification message.

Notification messages may either be synchronized to some audio/visual (A/V) content or notification messages may comprise a stand-alone service. Synchronized notification messages describe events that are related to some A/V service, e.g., requests for voting or contextual advertisements. Additionally, notification services may be aggregated, e.g., when carrying multiple notification messages that are close/similar to each other in their presentation time and small in size. Standalone notification services carry notification messages that are grouped by certain criteria but are not related to an A/V service. Furthermore, notification services may be “default” or “user selected.” Depending upon the type of the notification service at issue, the delivery of the notification messages may differ.

Two different transport protocols may be used for the delivery of notification messages over the broadcast channel (DVB-H): Real-time Transport Protocol (RTP) and File Delivery over Unidirectional Transport (FLUTE). FLUTE may be used for the delivery of un-synchronized/standalone and default notification messages. RTP is used mainly for the delivery of synchronized, service-related notification messages. Alternatively, a combination of RTP and FLUTE may be used, where the bulky payload of a notification message (e.g., the application-specific message part and media objects, if any) may be transported using FLUTE, while, e.g., only the generic message part of the notification message is delivered using RTP. Various message parts, other than the generic part, may be carried over FLUTE, in a session that is referred to by the generic message part. A similar extension to the File Delivery Table (FDT) of FLUTE has been defined to provide identification and fast access to information fields that are necessary for the selection of notification messages. The notification message parts may then be encapsulated and carried as a single transport object, or as separate transport objects. The generic message part will usually provide a list of the message parts that constitute the corresponding notification message. The references to media objects as well as a description of how they are to be used are generally provided by the application-specific message part.

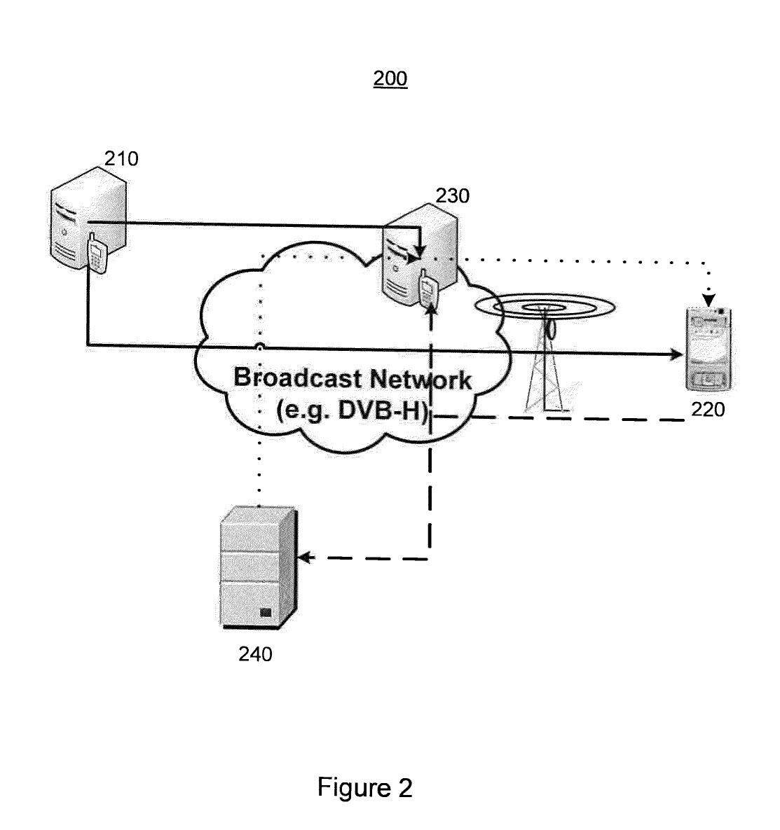

FIG. 2 illustrates an example system for mobile advertisement delivery in a broadcast network. In an example embodiment mobile advertisement delivery is carried, for example, over the broadcast channel DVB-H. In FIG. 2, a system 200 is shown to include a media content provide 210, e.g. mobile TV content provider, a receiving terminal 220, an advertisement inserter 230, and an advertisement provider 240. The media content provider 210 may be a content provider server, a user terminal and/or the like. The media content provider 210 provides media content to the terminal 220 over a broadcast network, e.g., the DVB-H network, as illustrated with the solid arrows. Media content comprises mobile TV content, streaming video content, audio content and/or the like. Additionally, the advertisement provider 240, e.g. mobile TV advertisement provider, communicates the advertising content to the advertisement inserter 230 for insertion into the media content received thereat, as illustrated by the dotted arrow. According to an example embodiment, the advertisement inserter 230 is implemented at the terminal 220. According to another example embodiment, the advertisement inserter 230 is implemented at a separate network server. The network server inserts the advertisement content into the media content and forwards the modified media content to the terminal 220.

In an example embodiment, a user may define his/her preferences and interests for the content of the advertisements that he/she wishes to receive. For example, the receiving terminal may send/be queried for certain data or information useful for better targeting and customizing of advertisements as illustrated by the dashed arrows between the receiving terminal 220, the advertisement inserter 230, and the advertisement provider 240. A network operator or the terminal 220 may determine the interests of the user based on the user behavior when using the terminal 220 or network. For example, the network or the terminal may analyze a web searching/search history of the user to determine user behavior.

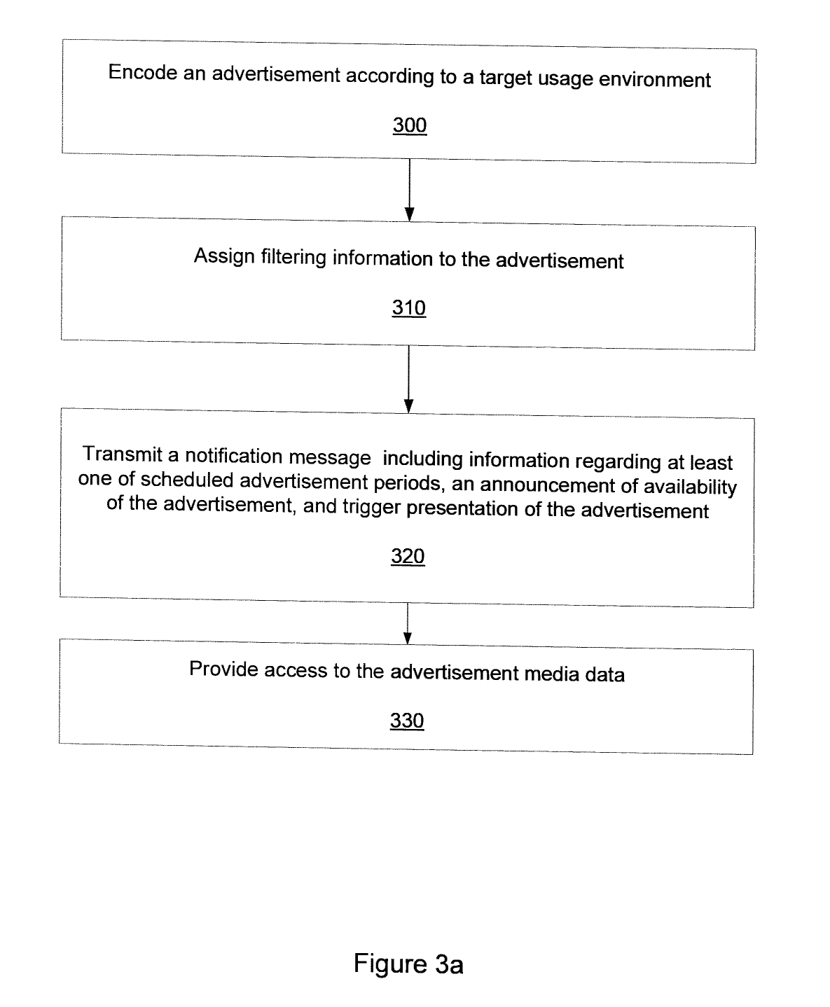

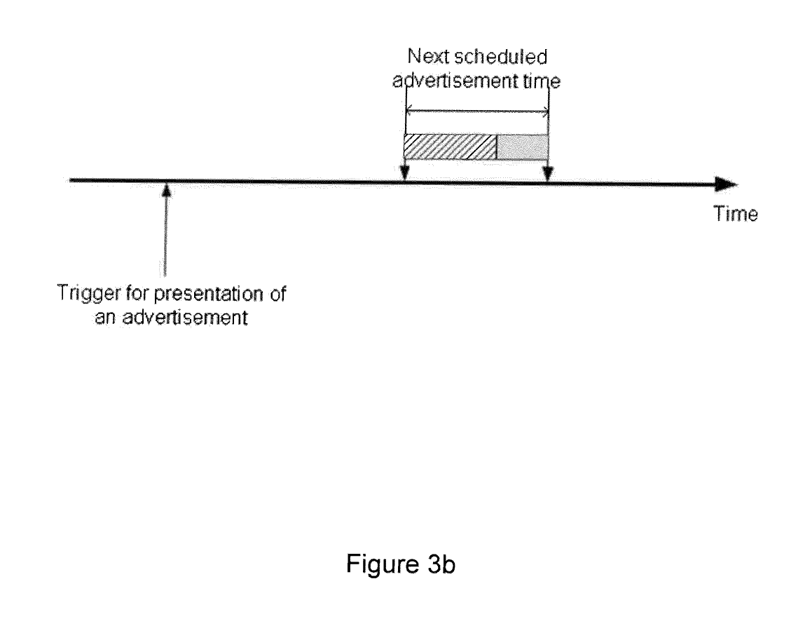

FIG. 3a is a flow chart illustrating a method performed at the network side in accordance with various embodiments, for delivering advertising content. At 300, content of an advertisement is encoded according to a target usage environment. For example, the advertisement content is encoded to have a similar or the same resolution and quality as the media content, e.g., mobile TV content and/or video content, being delivered to the user. The encoded advertisement content may be stored as media data, e.g., in the form of audio and/or video files or clips. At 310, filtering information is assigned to the advertisement or advertisement clip. For example, the network may define a set of filtering characteristics/criteria. A corresponding identifying value may be associated with each filtering characteristic or criterion. For at least one of the filtering characteristics/criteria the corresponding value(s) is assigned to the advertisement or advertisement clip.

At 320, at least one notification message, associated with a media stream, is transmitted, e.g. within a notification stream, to user terminals. The notification messages relate to one or more advertisements available to users during the consumption of a media stream, e.g., audio/video streams and/or mobile TV streams. The notification stream is defined to carry notification messages comprising information regarding at least one of scheduled advertisement period(s), an announcement of availability of the at least one advertisement and a trigger of presentation of an advertisement. Notification message(s) may further comprise information about the duration(s) of the at least one advertisement. The filtering information, for example, is carried within the notification message(s). Alternatively, the filtering information may also be included with the advertisement clip to which the filtering information is assigned, e.g., within corresponding metadata.

It should be noted that a service operator may transmit the advertisement content over the same channel as the media stream, e.g., the same channel over which the mobile TV content is being transmitted such as broadcast channel like DVB-H. Alternatively, the audio and/or video clips for the advertisement may be delivered over an announced channel. In another example embodiment, the network provides access to the advertisement content, for example, by informing users of the location of the advertisement content. At 330, access to advertisement content is provided. Users may then download advertisements that are of interest to them based at least in part pon received location information from the network.

In an example embodiment, a notification message, or the notification stream, is synchronized to the media stream, e.g., mobile TV media stream, an audio stream, a video stream and/or the like, being transmitted to user terminals. Alternatively, a notification message, or the notification stream, may also be synchronized to a media stream carrying the media data representative of advertisement content. In another example embodiment, a notification message, or the notification stream, is synchronized to both media streams carrying, respectively, media content data, e.g., mobile TV content, and advertisement content data.

In an example embodiment, the presentation of the advertisement is triggered by the user terminal, or user. For example, the user terminal, or user, decides the time instance(s) at which the advertisement is to be played based at least in part on the information within the received notification message(s). In another example embodiment, the presentation of the advertisement or advertisement clip is triggered by the server/network based on other criteria. In one particular embodiment, the server triggers the presentation of an advertisement for a product or service that is currently being shown in or is related to the content that is being consumed. Alternatively, presentation of an advertisement may run in parallel with actual TV content, such as a picture-in-picture implementation. The notification stream, or notification message(s), may also comprise information regarding a trigger for presentation of the at least one advertisement. Trigger information may also be sent to a user terminal, by a network server separate from notification message(s). Information about trigger of presentation of an advertisement comprises at least one of; information about when the advertisement to be played to the user and information about where the advertisement to be inserted within the media stream, and/or the like. A network server, for example, sends trigger information based at least in part on the content of the advertisement, the media content being transmitted in the media stream, the duration of the advertisement content, the location of a user terminal and/or the like. In yet another example embodiment, the advertisement content, e.g., advertisement clip(s), is inserted into media stream by a network server. The network server decides where to insert the advertisement content based at least in part on the content of the advertisement, the media content being transmitted in the media stream, the duration of the advertisement content, the location of a user terminal and/or the like. The network server, for example, decides to insert one or more advertisements in the

FIG. 3b illustrates the use of a trigger for the presentation of an advertisement in accordance with various embodiments. A timeline is shown in FIG. 3b with a period of time allocated for the next scheduled advertisement time. The solid-shaded portion of the period of time indicates available advertisement time. That is, this amount of time is useable to present customized or regular advertisements. The hash-shaded portion of the period of time is indicative of advertisement time that has already been exhausted, e.g., for the presentation of other customized advertisements, or already allocated for the presentation of other customized or non-customized advertisement. The trigger for the presentation of an advertisement is thus sent by, e.g., a server or the network, before the next scheduled advertisement time period arrives and in accordance with aforementioned other criteria.

From the perspective of a user terminal/device, advertisements, e.g., audio and/or video clips, based at least in part on the corresponding filtering information, e.g., classification/identification tags and/or other criteria, and the preference(s) and interest(s) of the user. The selected clips are stored within the receiving terminal's memory. In an example embodiment, the user terminal fetches the filtering information included in the notification message(s) and decides/determines which advertisement(s) are to be received by the user terminal. For example, the user terminal processes the filtering information, e.g., within notification message(s), and determines which advertisements are to be downloaded or requested from the network. The user terminal then downloads/receives the determined advertisements. In another example embodiment, the user terminal receives one or more advertisements. The user terminal filters the received advertisements based at least in part on the filtering information, e.g., in the notification message(s), metadata of the advertisement clips, and/or the like, and the user preferences to determine which advertisements may be of interest to the user. The determined advertisements are played to the user, for example, within announced scheduled advertisement periods.

Advertisement clips may have a “validity” time that gives control to the service provider over a particular set of advertisements that are currently being used or presented. Different mechanisms may trigger the display of a specific advertisement depending upon information contained in the advertisement, user preferences, and/or terminal implementation. Additionally, the terminal keeps track of displayed advertisement/advertisement clips and their total duration to ensure that this duration does not exceed the signaled/announced scheduled advertisement period(s). In an example embodiment, during display of the advertisement, local recording of the channel media streams may be performed to allow for later, “time-shifted playout” to catch up with a live transmission. Moreover, periodical reporting about consumed advertisements may be defined and generated for improved charging of the commercials provider. Reporting can also be used to accurately measure the effectiveness of the mobile advertisements.

A receiving user terminal/device may filter received advertisement clips. The filtering of advertisement clips may be realized based on, e.g., location information associated with a user, in order to enhance the relevance of the information that is provided together with the video clips. For example, when a user is currently located in/near a particular establishment or area, an advertisement relevant to the establishment or area may be transmitted to the user to, e.g., increase the impact of the advertisement. Each advertisement clip may also be bound to a display time in order to control the appropriate consumption of the advertisement. Further still, a priority may also be established between the different mobile advertisement clips to provide a differentiated service for the advertisements providers.

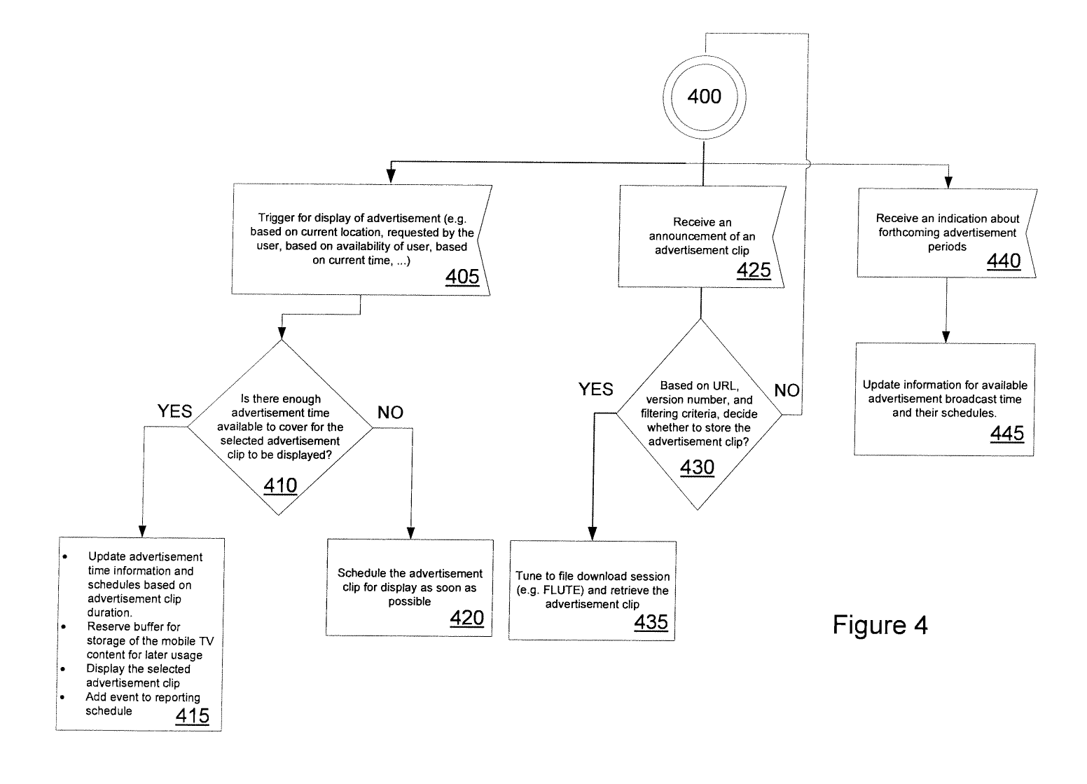

FIG. 4 is a flow chart illustrating example processes performed from a user terminal perspective regarding the receipt of advertisement(s) in accordance with various embodiments. At 400 a user terminal/device receives a notification message. The notification message may comprise a trigger for displaying an advertisement, an announcement of an advertisement clip, an indication regarding scheduled upcoming advertisement periods and/or the like. At 405, a trigger is received via the notification message, where the trigger is based at least in part on, for example, a current user terminal location, a request by the user, availability of the user, current time, etc. It should be noted that the trigger may also be based on other considerations. At 410, it is determined whether enough advertisement time is available to play back the advertisement clip selected/determined for display. If there is enough time, at 415, advertisement time information and advertisement schedules are updated based on the advertisement clip duration, and a buffer(s) is reserved for storage of the media content, e.g., mobile TV content, for later use. Additionally, the selected advertisement clip is displayed/presented and an event is added to a reporting schedule. If there is not enough available advertisement time, the advertisement clip is scheduled for display as soon as possible thereafter.

At 425, it is determined that the received notification comprises advertisement clip announcement. A notification is received in the announcement message(s) indicating the availability of an advertisement clip. At 430, it is determined whether or not to receive/store the advertisement clip, where the determination may be based on, e.g., an associated uniform resource locator (URL), version number, and/or filtering information. If the advertisement clip is to be received/stored, at 435, the user terminal tunes to a file download session (e.g., FLUTE) and retrieves that advertisement clip.

At 440, it is determined that the notification message received comprises an indication of upcoming advertisement periods. At 445, information for available advertisement broadcast time(s) and a respective schedule(s) is updated.

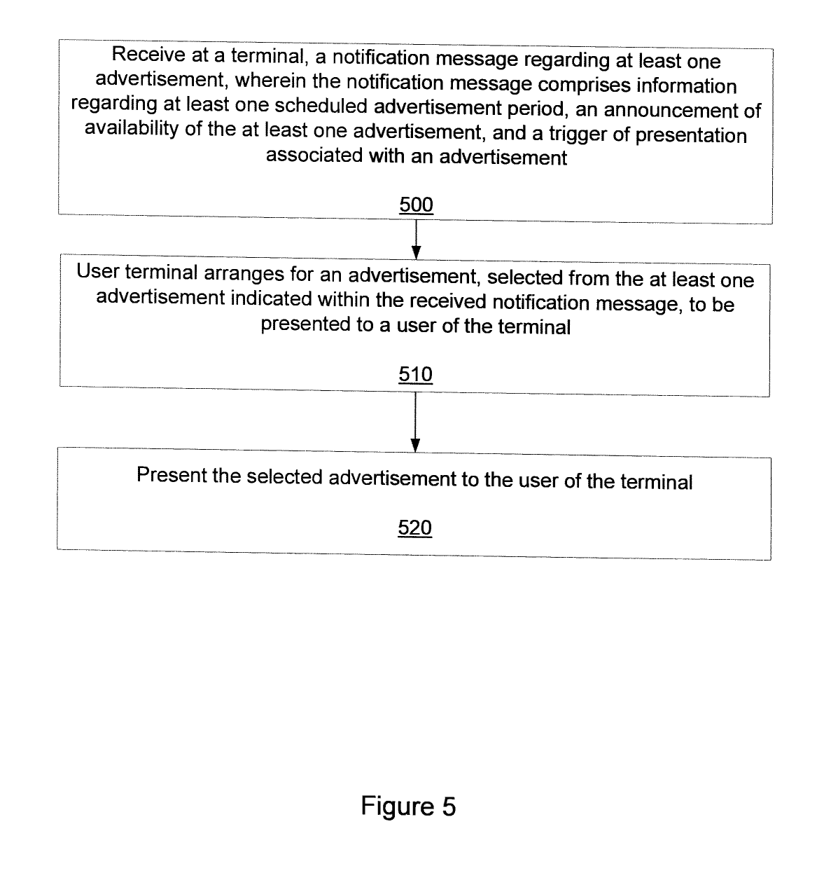

FIG. 5 is a flow chart illustrating processes performed for realizing customized mobile advertising in accordance with various embodiments from a user perspective. At 500, a notification message is received, regarding at least one advertisement, wherein the notification message comprises information about at least one of; an announcement of availability of the at least one advertisement, scheduled advertisement periods, and a trigger of presentation/displaying of an advertisement. The notification message may further comprise filtering information assigned with the at least one advertisement. In an example embodiment, the notification message, or a notification stream, is synchronized to a media stream, e.g., mobile TV media stream, an audio stream, a video stream and/or the like, being received by the user terminal 220. Alternatively, the notification message, or the notification stream, may also be synchronized to a media stream carrying the media data representative of advertisement content. In another example embodiment, the notification message, or the notification stream, is synchronized to both media streams carrying, respectively, media content data, e.g., mobile TV content, and advertisement content data. At 510, user terminal arranges for an advertisement, selected from the at least one advertisement indicated within the received notification message, to be presented to the user. Arranging for the presentation of a selected advertisement comprises selecting the advertisement, receiving/retrieving the content of the selected advertisement and/or assigning a time period, e.g., within scheduled advertisement periods, for presenting the selected advertisement. The selection of the advertisement may be based at least in part on the filtering information assigned to the at least one advertisement indicated in the notification message, user preferences and/or a trigger of presentation of the advertisement. The advertisement content may be, for example, downloaded by the terminal, or received from the network on a broadcast channel or other channel(s). At 520, the selected advertisement is presented at the user of the terminal.

In arranging for the presentation/display of the advertisement, a terminal checks if sufficient advertisement time is available, within next scheduled advertisement period. For example, if remaining advertisement time, e.g., not reserved for displaying other advertisements, is longer than the duration of the selected advertisement then advertisement time within the next scheduled advertisement period is reserved for displaying/presenting the selected advertisement. If there is no sufficient time, within the next scheduled advertisement period, the display/presentation of the selected advertisement is scheduled at a later time, e.g., within a later advertisement period. An announcement of the availability of an advertisement file(s) comprises, for example, an indication of the location of the advertisement file(s), e.g., a uniform source locator URL. The announcement may further comprise other information such as the format(s) and/or the size(s) of the advertisement file(s).

In accordance with one embodiment, the DVB notification framework is used to convey the media data (e.g., video clips) for advertisements and the notifications about the advertisement periods. A notification application is defined for this purposes, where notification messages are identified by a specific Multipurpose Internet Mail Extension (MIME) type (e.g., “application/org.dvb.notif.mobads+xml”). The mobile advertisement clips are transmitted over a dedicated FLUTE session for all associated mobile TV channels (e.g., in the electronic service guide (ESG) Default Notification channel). Alternatively, a session may be associated with a specific mobile TV channel.

At least two notification message sub-types may be defined in accordance with various embodiments. A first sub-type is referred to as “AD_ANNOUNCE,” which comprises an announcement of the availability of an advertisement media clip. The AD_ANNOUNCE message is used to provide a link to, e.g., a video clip, that contains the desired mobile advertisement. The AD_ANNOUNCE message also contains information about the filtering criteria that apply to the advertisement clip. A second notification message sub-type is referred to as “AD_PERIOD_INFO,” which comprises an indication of the start of an advertisement period and its duration. Yet another notification message type may be referred to as “AD_PRESENT,” which comprises the trigger for the presentation of an advertisement which may be sent by the server/network.

The media clip announcement message (i.e., AD_ANNOUNCE) may contain the following information including, but not limited to: validity of the mobile advertisement clip; the expiry of the advertisement clip validity time for triggering removal of the advertisement clip from the receiving terminal's storage; suitability information that comprises information regarding, for example, an appropriate time and/or location, during which and/or where it is preferable to display the advertisement clip. Additionally, the media clip announcement message may further contain the following information: filtering information that contains the filtering information relevant to the filtering criteria used by the terminal to select the appropriate advertisement content, where user preferences may be collected in the form of filtering information to a predefined set of filtering criteria; clip duration, which includes information about the duration of the given advertisement clip; and a pointer to the media clip(s) to be downloaded for the particular advertisement clip.

The Ad period indication message (i.e., AD_PERIOD_INFO) contains the start and end, or the start and duration of a next advertisement period(s). The start and end times may be indicated as 64-bit network time protocol (NTP) timestamps to allow for accurate synchronization to the relevant mobile TV channel streams. Alternatively, the RTP timestamp of the AD_PERIOD_INFO notification message may be used to achieve the desired synchronization.

The following is an example of an XML schema for the application-specific message part that is designed in accordance with various embodiments. The XML schema defines the two message types, AD_ANNOUNCE and AD_PERIOD_INFO.

```
<?xml version=″1.0” encoding=”UTF-8”?>
<xs:schema xmlns=”urn:dvb:ipdc:notif:application:mobiad:2008”
    targetNamespace=”urn:dvb:ipdc:notif:application:mobiad:2008”
    elementFromDefault=”qualified”/>
<xs:element name=”MobileAd” type=”MobileAdType”/>
<xs:complexType name=”MobileAdType”>
  <xs:choice>
      <xs:element name=”AdAnnounce” type=”AdAnnounceType”/>
      <xs:element name=”AdPeriodInfo” type=”AdPeriodInfoType”/>
  </xs:choice>
</xs:complexType>
<xs:complexType name=”AdAnnounceType”>
  <xs:sequence>
      <xs:element name=”FilterInformation” type=”FilterInformationType”/>
      <xs:element name=”LocationInformation” type=”LocationInformationType”
minOccurs=”0” maxOccurs=”unbounded”/>
  </xs:sequence>
  <xs:attribute name=”VideoClip” type=”xs:anyURI” use=”required”/>
  <xs:attribute name=”Version” type=”xs:unsignedInt” use=”required”/>
  <xs:attribute name=”VideoDuration” type=”xs:unsignedLong” use=”optional”/>
  <xs:attribute name=”ValidFrom” type=”xs:unsignedLong” use=”optional”/>
  <xs:attribute name=”ValidTo” type=”xs:unsignedLong” use=”optional”/>
  <xs:attribute name=”ReportToServer” type=”xs:anyURI” use=”optional”/>
</xs:complexType>
<xs:complexType name=”AdPeriodInfoType”>
  <xs:sequence>
      <xs:element name=”AdPeriod” type =”AdPeriodType” minOccurs=”1”
maxOccurs=”unbounded”/>
  </xs:sequence>
</xs:complexType>
<xs:complexType name=”AdPeriodType”>
  <xs:attribute name=”Start” type=”xs:unsignedLong” use=”required”/>
<xs:attribute name=”End” type=”xs:unsignedLong” use=”optional”/>
<xs:attribute name=”Duration” type=”xs:unsignedLong” use=”optional”/>
</xs:complexType>
<xs:complexType name=”LocationInformationType”>
  <xs:attribute name=”Latitude” type=”” use=”required”/>
  <xs:attribute name=”Longitude” type=”” use=”required”/>
  <xs:attribute name=”Perimeter” type=”” use=”required”/>
</xs:complexType>
</xs:schema>
```

As indicated in the exemplary XML schema above, an indication of the geographic location in which a current advertisement clip is appropriate is given by the (Latitude, Longitude, Perimeter) tuple. It should be noted that other forms of indicating a target geographic area could also be used, e.g., the Cell-ID in a broadcast network, street location, etc.

Information about the server to which consumption of an advertisement is to be reported may also be determined in order to enable accurate collection of advertisement viewing statistics. The generated load may be limited by reporting rules that limit reporting frequency, reporting fraction of receivers, aggregation of reports, etc.

Various embodiments allow for the fully customized consumption of advertisements. A receiving terminal/device can decide to display an appropriate advertisement based on user preference, location, and actual time, among other considerations. Given the duration of an upcoming advertisement interruption on a regular broadcast, the receiving terminal is able to display advertisements in advance of the upcoming advertisement period. This allows higher efficiency to be achieved with regard to advertisements by selecting the appropriate time of display to a user. Moreover, it should be noted that various embodiments described herein are not restricted to a mobile TV context. For example, various embodiments may be applicable to any type of linear broadcast TV context.

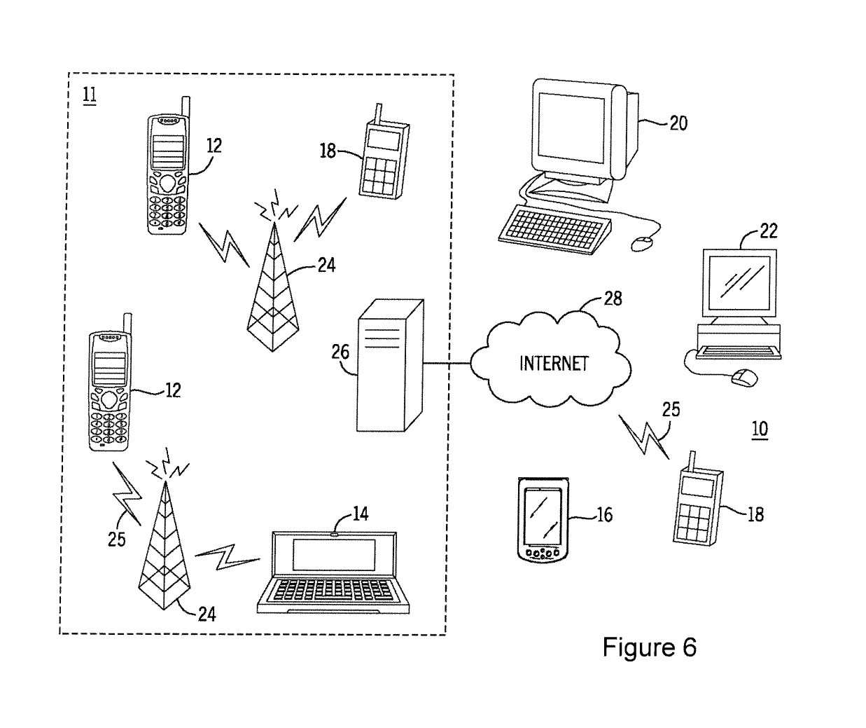

FIG. 6 shows a system 10 in which various embodiments can be utilized, comprising multiple user terminals/devices that can communicate through one or more networks. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices acting as, e.g., receiving terminals such as those described above.

The system 10 shown in FIG. 6 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The example user terminals/devices of the system 10 may include, but are not limited to, an electronic device 12 in the form of a mobile telephone, a combination personal digital assistant (PDA) and mobile telephone 14, a PDA 16, an integrated messaging device (IMD) 18, a desktop computer 20, a notebook computer 22, etc. The user terminals/devices may be stationary or mobile as when carried by an individual who is moving. The communication devices may also be located in a mode of transportation including, but not limited to, an automobile, a truck, a taxi, a bus, a train, a boat, an airplane, a bicycle, a motorcycle, etc. Some or all of the communication devices, or user terminals, may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The user terminals/devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, IEEE 802.16, LTE (3GPP Long-Term Evolution) etc. A communication device involved in implementing various embodiments may communicate using various media including, but not limited to, radio, infrared, laser, cable connection, and the like.

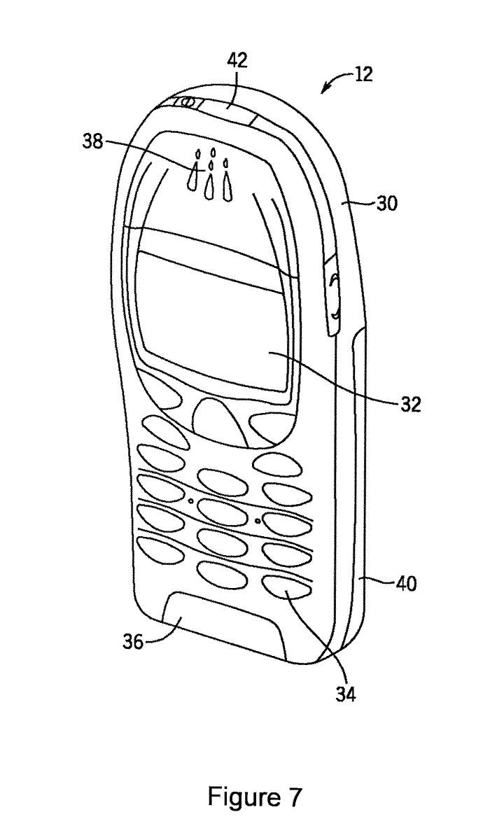

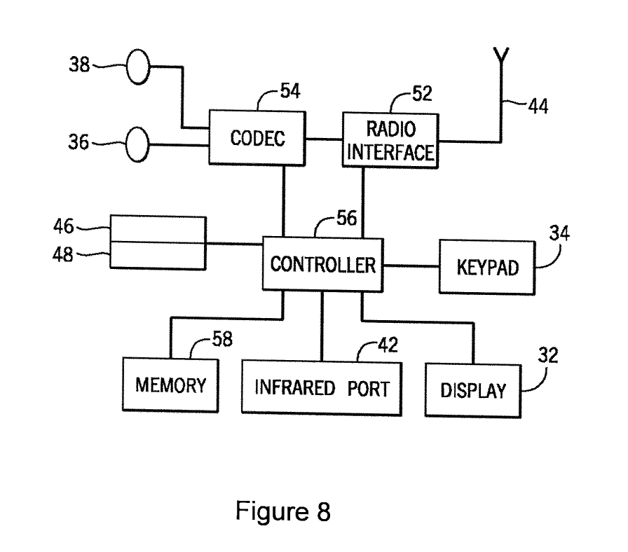

FIGS. 7 and 8 show one representative electronic device 12 within which various embodiments may be implemented. It should be understood, however, that various embodiments are not intended to be limited to one particular type of device. The electronic device 12 of FIGS. 7 and 8 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment, a card reader 48, radio interface circuitry 52, codec circuitry 54, a controller 56 and a memory 58. Individual circuits and elements are all of a type well known in the art, for example in the Nokia range of mobile telephones.

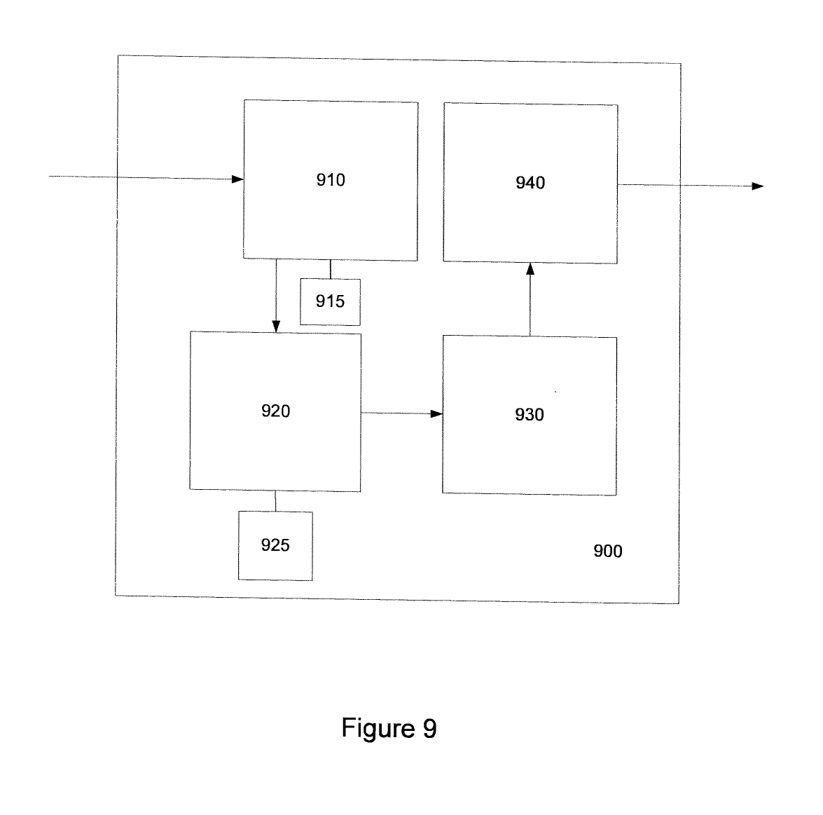

FIG. 9 shows a representative server 900 within which various embodiments may be implemented. The server may be a network server that performs various processes as described above with regard to FIG. 3a. That is, a receiver 910 receives user preferences and/or interests regarding advertisement content, where the user preferences may be received from the user or determined at the network. Alternatively, the server itself may determine such user preferences and/or interests via a processor 915. An encoder 920 encodes the advertisement content according to a target usage environment, and the encoded advertisement content may be stored as media data in a memory 925. A tagging module 930 performs a tagging process to assign, to each advertisement, the corresponding applicable filtering criteria defined, e.g., by the network. A transmitter 940 subsequently transmits the media data (A/V/clips) of the advertisement in an A/V stream along with a notification stream. It should be understood that more or less elements may be implemented within the server 900 for performing the above-described processes. Additionally, certain server elements/functionalities may be combined, where processes may be performed together such as by, e.g., a transceiver, that combines the functionality of the receiver 910 and the transmitter 940.

Various embodiments described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Various embodiments may be implemented in software, hardware, application logic or a combination of software, hardware and application logic. The software, application logic and/or hardware may reside, for example, on a chipset, a mobile device, a desktop, a laptop or a server. Software and web implementations of various embodiments can be accomplished with standard programming techniques with rule-based logic and other logic to accomplish various database searching steps or processes, correlation steps or processes, comparison steps or processes and decision steps or processes. Various embodiments may also be fully or partially implemented within network elements or modules. It should be noted that the words “component” and “module,” as used herein and in the following claims, is intended to encompass implementations using one or more lines of software code, and/or hardware implementations, and/or equipment for receiving manual inputs.

Individual and specific structures described in the foregoing examples should be understood as constituting representative structure of means for performing specific functions described in the following the claims, although limitations in the claims should not be interpreted as constituting “means plus function” limitations in the event that the term “means” is not used therein. Additionally, the use of the term “step” in the foregoing description should not be used to construe any specific limitation in the claims as constituting a “step plus function” limitation. To the extent that individual references, including issued patents, patent applications, and non-patent publications, are described or otherwise mentioned herein, such references are not intended and should not be interpreted as limiting the scope of the following claims.

The foregoing description of embodiments has been presented for purposes of illustration and description. The foregoing description is not intended to be exhaustive or to limit various embodiments to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize various embodiments and with various modifications as are suited to the particular use contemplated. The features of various embodiments described herein may be combined in all possible combinations of methods, apparatus, modules, systems, and computer program products.

What is claimed is:

1. A method, comprising:
encoding an advertisement according to a target usage environment;
assigning filtering information to the advertisement, said filtering information allowing customized selection of the advertisement;
transmitting a notification message comprising information regarding at least one of scheduled advertisement periods, announcement of availability of the advertisement and trigger of presentation of the advertisement; and
providing access to the advertisement media data.

2. A computer program product, embodied on a computer-readable medium, comprising computer code instructions, when executed by a processor, cause an apparatus to perform the processes of claim 1.

3. An apparatus, comprising:
a processor, and
memory including computer program code,
the memory and the computer program code configured to, working with the processor, cause the apparatus to perform at least the following:
encode an advertisement according to a target usage environment;
assign filtering information to the advertisement, said filtering information allowing customized selection of the advertisement; and
transmit a notification message comprising information regarding at least one of scheduled advertisement periods, announcement of availability of the advertisement and trigger of presentation of the advertisement; and
provide access to the advertisement media data.

4. The apparatus of claim 3, wherein said notification message being transmitted within a notification stream, said notification stream being synchronized with at least one of a transmitted media stream and an advertisement media data stream, said media stream comprises at least one of a mobile TV stream and an audio/video stream.

5. The apparatus of claim 3, wherein said filtering information comprises at least one of location information associated with the advertisement, information about the content of the advertisement, a display time, and priority information with respect to at least another advertisement.

6. The apparatus of claim 4, wherein the media stream being transmitted over a digital video broadcasting-handheld channel.

7. The apparatus of claim 3, wherein the memory and the computer program code being further configured to, working with the processor, cause the apparatus to transmit the advertisement media data and the notification stream using a dedicated file delivery over unidirectional transport protocol.

8. The apparatus of claim 3, wherein said notification message comprises at least one of:
AD_ANNOUNCE subtype announcing the availability of the advertisement and comprising at least one of a link to a storage location of the advertisement content, filtering information, validity information, suitability information and duration information, wherein said link to a storage location indicating a location for retrieving the advertisement content;
AD_PRESENT subtype comprising information about a trigger of presentation of the advertisement, said information about a trigger comprises at least one of presentation time, pointer to the advertisement, highlighting information relative to a content of media stream relating to an advertised product/service, and a uniform resource locator to a web site that contains further information about the advertised product/service; and
AD_PERIOD_INFO subtype comprising at least one of a start, an end, and a duration of the advertisement and at least one of a start, an end, and a duration of a next advertisement period.

9. A method, comprising:
receiving at a terminal, a notification message regarding at least one advertisement, wherein the notification message comprises information regarding at least one of a scheduled advertisement period, announcement of availability of the at least one advertisement and a trigger of presentation associated with an advertisement;
arranging, by the terminal, for presentation of an advertisement selected from said at least one advertisement; and
presenting the selected advertisement to a user of the terminal.

10. The method of claim 9, wherein arranging for the presentation of a selected advertisement comprises at least one of:
selecting the advertisement based at least in part on filtering information received in the notification message;
receiving the selected advertisement media data; and
assigning a time period for presenting the selected advertisement.

11. The method of claim 9 further comprising performing at least one of updating advertisement time information and schedules based on a duration of the selected advertisement, reserving a buffer for storage of media stream content for later usage, and adding an event to a reporting schedule, upon presenting the selected advertisement

12. The method of claim 9, wherein receipt of the notification message occurs via a notification stream, said notification stream being synchronized with at least one of a transmitted media stream and an advertisement media data stream, said media stream comprises at least one of a mobile TV stream and an audio/video stream.

13. The method of claim 9, wherein the notification messages comprise at least one of:
AD_ANNOUNCE subtype announcing the availability of the advertisement and comprising at least one of a link to a storage location of the advertisement content, filtering information, validity information, suitability information and duration information, wherein said link to a storage location indicating a location for retrieving the advertisement content;
AD_PRESENT subtype comprising information about a trigger of presentation of the advertisement, said information about a trigger comprises at least one of presentation time, pointer to the advertisement, highlighting information relative to a content of media stream relating to an advertised product/service, and a uniform resource locator to a web site that contains further information about the advertised product/service; and
AD_PERIOD_INFO subtype comprising at least one of a start, an end, and a duration of the advertisement and at least one of a start, an end, and a duration of a next advertisement period.

14. A computer program product, embodied on a computer-readable medium, comprising computer code instructions, when executed by a processor, cause an apparatus to perform the processes of claim 9.

15. An apparatus, comprising:
a processor, and
memory including computer program code,
the memory and the computer program code configured to, working with the processor, cause the apparatus to perform at least the following:
receive a notification message regarding at least one advertisement, wherein the notification message comprises information regarding at least one of a scheduled advertisement period, announcement of availability of the at least one advertisement and a trigger of presentation associated with an advertisement;
arrange for presentation of an advertisement selected from said at least one advertisement; and
present the selected advertisement to a user of the terminal.

16. The apparatus of claim 15, wherein the memory and the computer program code being further configured to, working with the processor, cause the apparatus, in arranging for the presentation of a selected advertisement, to:
select the advertisement based at least in part on filtering information received in the notification message;
receive the selected advertisement media data; and
assign a time period for presenting the selected advertisement.

17. The apparatus of claim 15, wherein the memory and the computer program code being further configured to, working with the processor, cause the apparatus to tune to a file download session and to;
download the selected advertisement media data, or
download the at least one advertisement media data.

18. The apparatus of claim 15, wherein the memory and the computer program code being further configured to, working with the processor, cause the apparatus to perform at least one of update advertisement time information and schedules based on a duration of the selected advertisement, reserve a buffer for storage of media stream content for later usage, and add an event to a reporting schedule, upon presenting the selected advertisement

19. The apparatus of claim 15, wherein receipt of the notification message occurs via a notification stream, said notification stream being synchronized with at least one of a transmitted media stream and an advertisement media data stream, said media stream comprises at least one of a mobile TV stream and an audio/video stream.

20. The apparatus of claim 16, wherein the selected advertisement media data being received over a digital video broadcasting-handheld channel.

21. The apparatus of claim 15, wherein receiving of the notification message occurs using a dedicated file delivery over unidirectional transport protocol.

22. The apparatus of claim 15, wherein the notification messages comprise at least one of:
AD_ANNOUNCE subtype announcing the availability of the advertisement and comprising at least one of a link to a storage location of the advertisement content, filtering information, validity information, suitability information and duration information, wherein said link to a storage location indicating a location for retrieving the advertisement content;
AD_PRESENT subtype comprising information about a trigger of presentation of the advertisement, said information about a trigger comprises at least one of presentation time, pointer to the advertisement, highlighting information relative to a content of media stream relating to an advertised product/service, and a uniform resource locator to a web site that contains further information about the advertised product/service; and
AD_PERIOD_INFO subtype comprising at least one of a start, an end, and a duration of the advertisement and at least one of a start, an end, and a duration of a next advertisement period.

23. The apparatus of claim 15, wherein the apparatus comprises a mobile phone.
